(19) United States
(12) Patent Application Publication
(10) Pub. No.: US 2008/0281734 A1
(43) Pub. Date: Nov. 13, 2008

(54) SYSTEM AND METHOD FOR INTEGRATED CREDIT APPLICATION AND TAX REFUND ESTIMATION

(75) Inventors: Brian Longe, Minneapolis, MN (US); Stacey Gillard, Edinburg, TX (US); Brad Fleener, Minneapolis, MN (US); Parameswaran Ramakrishnan, Baton Rouge, LA (US)

Correspondence Address: FOLEY & LARDNER LLP, 321 NORTH CLARK STREET, SUITE 2800, CHICAGO, IL, 60610-4764, US

(73) Assignee: AppOne Services, Inc.

(21) Appl. No.: 12/115,458

(22) Filed: May 5, 2008

Related U.S. Application Data
(63) Continuation-in-part of application No. 11/733,055, filed on Apr. 9, 2007.
Application No. 11/733,055 is a continuation-in-part of application No. 11/164,688, filed on Dec. 1, 2005.
(60) Provisional application No. 60/595,488, filed on Jul. 11, 2005.

(51) Int. Cl. G06Q 40/00; G06Q 10/00

(52) U.S. Cl. 705/31; 705/38

(57) ABSTRACT

Systems and methods for handling multiple aspects of the acquisition of products and/or services, such as vehicles, are provided in a unified and streamlined fashion. Through an integrated credit application and tax refund estimation service application/systems, credit application-related data and non-overlapping tax-related data is captured. A tax refund is estimated based upon the tax-related data and at least a portion of the credit application-related data. Upon a determination to utilize at least a portion of the estimated tax refund as at least a portion of a down payment on a loan, at least a portion of the estimated tax refund is incorporated into a deal structure of the loan, and a credit application including the deal structure and at least the credit application-related data is submitted for a decision.

### CROSS-REFERENCE TO RELATED PATENT APPLICATIONS

This application is a continuation-in-part of copending U.S. patent application Ser. No. 11/733,055, entitled “Vehicle Dealer Rating Method” filed on Apr. 9, 2007, which is a continuation-in-part of U.S. patent application Ser. No. 11/164,688, entitled “Meta-Marketplace Method” filed on Dec. 1, 2005, which claims priority to U.S. Provisional Application No. 60/595,488, filed Jul. 11, 2005, each of which are incorporated herein by reference in their entirety.

### FIELD OF THE INVENTION

The present invention relates generally to indirect lending business processes. More particularly, the present invention relates to systems and methods of integrated credit application and tax refund estimation, for efficiently handling various aspects of purchase, and/or financing transactions.

### BACKGROUND OF THE INVENTION

In the traditional mode of vehicle acquisition, many individual transactions must be performed in order to complete a transaction, such as pre-qualification for financing, organization of value-added products, insurance and more. Each of these transactions must be handled one at a time, with qualification and/or applicability evaluated for each by a retailer and each party involved. Financing must be qualified, applied for, negotiated, and finalized. Insurance services must be determined for each transaction. Value-added services such as warranties, must be determined on a case-by-case basis. Trades, payoffs and purchases are handled separately. In short, each aspect of the vehicle acquisition transaction is handled individually as part of a single acquisition making the overall experience time consuming, complex and prone to error, both because of retailer inexperience and high turnover in the retail vehicle industry, as well as the typical complications that arise from such an involved transaction.

Further, from a service and product provider's standpoint, the system is fraught with complication as well. Retailers must be trained on many different systems, which not only amount to difficulty from a transactional standpoint, but can have legal ramifications as well. For example, serious repercussions can arise should consumer credit laws not be fully complied with. Additionally, retailers generally do not have the resources or know how to have working relationships with lenders, and certainly do not have the capability to have such relationships with multiple lenders in order to better match consumers to financial institutions. As a result, the ability to negotiate diminishes. Smaller retailers may also not be savvy enough to be cognizant of, much less knowledgeable in, many emerging developments and/or finer points of the transaction, such as extended warranties, GAP insurance and the like. They may also be unaware or unable to exploit additional fee income opportunities, like VIN etching, credit insurance or special credit insurance.

From a lender's perspective, the system is also less than perfect. Risk management in the used car financing realm is commonly filled with defaults, slow pays and collection issues. Reaching the appropriate customers for a financial institution is a “hit or miss” strategy at best, with lenders pointlessly charging many dollars in application fees which will likely never come to fruition. A large number of applications are also never approved, which translates to wasted time and money on the processing of unqualified applicants.

Similarly, other services and product providers are often unable to tap an appreciable percentage of the market because impediments to the market exist. Cost, time and the simple knowledge of who to target leave these providers generally to deal with only a portion of the franchise retailers, who comprise less than half of the estimated overall market, leaving independents as a giant untapped resource. Expanding the product base to the many retailers that may not be implementing products and services such as GAP insurance and extended warranties is thus a goal as well.

Obvious downsides to the current method of retail exist. Having to individually handle each component of these vehicle transactions, coupled with the numerous vendors of the varying services, makes the dispensation of the transaction a long and arduous task, as well as making the single act of acquiring an automobile a multi-faceted process rife with the possibility of error and inefficiency. For example, certain financial institutions only offer financing to customers' of certain financial aptitude, making submission of some customers' lending requests a moot issue. Certain other value-added services should be offered, e.g., the option to utilize a customer's estimated tax refund to meet down payment requirements associated with the purchase of one or more particular goods and/or services, and oft are not, effectually missing sales. Compliance and consumer credit are required for certain portions of a transaction, and not others. All these nuances in the transaction, coupled with the relative lack of knowledge (partly as result of high turnover) in the vehicle sales representative business, make mistakes and time commitment a very relevant issue.

For example, various operations may be performed by a retailer when processing/completing a consumer loan credit application for an applicant (e.g., a potential vehicle purchaser) in accordance with conventional systems and methods. Generally, a finance professional captures an applicant's name, social security number, address of residence, employment information, income data, bank reference information, and other relevant data. This captured information then allows the financial professional to make a determination regarding, for example, the creditworthiness of the applicant, the degree of risk the retailer/lender/underwriter would undertake in approving a consumer loan for the applicant, supporting terms for underwriting the consumer loan, etc.

Likewise, conventional tax filing/refund estimation systems and methods require a qualified financial (or tax) professional to again capture information substantially similar to that information described above for processing/completing a consumer loan credit application. Additionally, the qualified financial (or tax) professional captures annual earnings information, tax withholding data, the applicant's number of dependents, qualified tax credits, and/or any other information relevant to estimating the applicant's pending tax refund. Thereafter, the qualified financial (or tax) professional is able to estimate an applicant's pending tax refund.

Other inventors have attempted to address the presented problem, such as the inventions disclosed in U.S. Pat. Nos. 5,878,403 and 6,587,841 to DeFrancesco and 6,208,979 to Sinclair. However, these references only address the issue of loan applications, and do not address the entire scope of processes, systems, services, entities, etc. in a market system.

All of these aspects of the current mode of retailing lead to an increased need for a revised method of product and/or service acquisition with minimized cost and complexity.

### OBJECTS OF THE INVENTION

One object of the invention is to provide a method for handling vehicle acquisition transactions.

Another object of this invention is to provide a method for handling multiple aspects of vehicle acquisition transactions in a single interface.

Yet another object of this invention is to provide a method for handling vehicle acquisitions in a more efficient manner.

Still another object of this invention is to provide a method for vehicle acquisition with decreased complexity for all parties involved in such a transaction.

Still another object of this invention is to provide to financial institutions and other product/service providers a more voluminous, more qualified consumer base to which to offer their services.

Still another object of this invention is to better equip retailer to offer a full spectrum of financing and product offerings to better suit customers and increase revenues.

Still another object of this invention is to reduce number of interaction points between financial institutions/banks, product and service providers and retailers.

Still another object of this invention is to provide a “one-stop shop” services provider for all parties to the vehicular transaction.

Still another object of this invention is to effectively manage dealer risk through the tools and processes of the present invention.

Still another object of this invention is to provide services to both retailers and lenders and service providers by leveraging technology.

Still another object of this invention is to provide a scoring system that aids lenders and service providers in selecting retailers that best fit their business model and goals.

Still another object of the this invention is to provide an integrated credit application and tax refund estimation service.

Other objects and advantages of this invention shall become apparent from the ensuing descriptions of the invention.

### SUMMARY OF THE INVENTION

According to the present invention, a method for handling multiple aspects of the acquisition of products and/or services, such as automobiles and trucks, in a unified and streamlined fashion is disclosed. A system for acquisition of products and/or services that integrates various product and service providers with retailers and consumers is presented from various aspects in order to realize efficiencies and opportunities that are impossible in the present mode of product and/or service acquisition. A scoring and/or ranking system for retailers is also disclosed. Additionally, systems and methods are provided for integrated credit application and tax refund estimation in product and/or service purchasing and/or financing.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a diagram showing the primary players in the metamarket method;

FIG. 2 is a diagram showing the vehicle acquisition process in the traditional method;

FIG. 3 is a diagram showing the vehicle acquisition process in the metamediary method;

FIG. 4 is a diagram showing weighting percentages of an exemplary embodiment of the scoring method;

FIG. 5 is a diagram showing a calculation breakdown of an exemplary embodiment of the scoring method;

FIG. 6 is a graphical representation of an exemplary architecture in which various embodiments are implemented; and

FIG. 7 is a flow illustrating exemplary processes performed to enable integrated credit application and tax refund estimation in accordance with various embodiments.

### DETAILED DESCRIPTION OF THE PREFERRED EMBODIMENTS

The consequence of the issues described above are, e.g., delayed acquisition, loss of sales, reduced productivity, consumer dissatisfaction, increased floor plan expenses, increased floor plan expenses, increases in lender processing, loss of value-added product sales, possible compliance violations and other lost opportunities for consumers, financiers and retailers.

Various embodiments of the present invention enabling a unified transaction provide a much-improved mode of handling this acquisition process, primarily because it overcomes the multitude of problems recited above by unifying the transactions into a single process, decreasing complexity and costs while simultaneously increasing productivity, breadth of products and offerings available, the number of retailer and service provider relationships, volume of sales and products sold as well as consumer satisfaction. This overall transactional process can be defined as a “metamarket,” or a set of related activities that accomplish a single consumer goal. In this case, the metamarket goal is that of the acquisition of an automobile.

In addition to the inherent efficiencies of a metamarket driven by a metamediary, another benefit of the present invention is the resultant drastic reduction in risk and optimized risk management for retailers and lenders in the vehicle acquisition transaction. In the present invention, the “metamediary” (or third party that routes information to appropriate destinations to present a seamless approach to the consumer) has the option to undertake the risk associated with the transaction, such as repossession, collections, re-purchase and the like. In this way, the retailer and bank can be at least partially absolved of responsibility associated with these aspects of the lending transaction, as the metamediary may simply buy back the loan, and undertake to collect or repossess as necessary. It is also possible for a metamediary to perform tasks such as these either internally on their own, or to employ the assistance of a third party in such tasks. Having a cooperative retailer repurchase the repossessed automobiles would also be an option, which could benefit both parties to such a transaction and be yet another aspect of this invention.

Risk is further mitigated by checking for retailer integrity, performing background checks, which aid in the prevention of fraud perpetuated on lenders. All parties can be checked as well, for credit background, financials and the like on all parties involved. This is imperative because the principals of the business may be “clean,” but all parties involved should be checked, such as the finance manager, credit manager and so forth. This helps to encourage lenders and other service providers to deal with the smaller retailers, since lenders are often reluctant to deal with retailers whose integrity they cannot account for. It thus becomes easier to track down and manage bad dealers. The present system thus establishes proper dealer setup procedures, complete with risk management tools. System alerts, thresholds and notifications can be setup to help mitigate risk as well. This type of system can detect loan “hopping” whereby a customer goes from retailer to retailer in an attempt to get a loan. This type of system can detect this behavior and notify the system operator of same. Effective data management by the metamediary thus enables much better client, consumer, lender and service provider management so that the metamarket as a whole is more organic rather than the current mode of disjointed processes.

As part of this process of connecting retailers to lenders and other service providers, the retailers' integrity and fitness for transactions becomes a primary concern. Fitness in this case refers to a retailer's ability to fulfill contract terms, determine their longevity in the marketplace and to otherwise be a viable business partner. This is accomplished using a scoring or rating system that evaluates various aspects of a retailer's business, helping lenders and other service providers to better select their business partners, and to know better what parameters to operate under with different “levels” of retailer. The metamediary can perform this scoring task on the business partners (retailers, etc.) “behind the scenes” and offer simply the most qualified parties to do business with, or, offer lenders and those seeing business partners the option to do business only with parties that meet a certain score level.

Of course, there are good reasons for lenders and service providers to be cautious, since it is not unheard of for retailers to (either intentionally or negligently) setup so-called straw purchases, wherein one party signs a loan to purchase a car for someone else; in essence, the party responsible for the loan is not the party who will be driving or housing the automobile. This type of arrangement leads to banks not being able to locate the automobile if and when a repossession is required; therefore this method helps to eliminate risks such as these, and this is but one example of the problems that can be reduced or eradicated by having the metamediary manage the metamarket.

Various embodiments of the present invention are applicable to, e.g., various retailers, including car, marine and RV dealers, both franchise (manufacturer-oriented) and individual (local pre-owned) retailers. Other dealers of products and/or services with a similar business plan could also feasibly benefit from this type of system. Individual retailers are more targeted by the present invention, since they stand to gain more from the present invention, and they generally have less infrastructure set up for the aspects of the vehicle acquisition transactions than do the franchise retailers. They also generally do not have the resources or expertise to deal with multiple banks, or other preferred sources of financing. And since there are estimated to be over twice as many individual retailers (55,000 estimated as of this writing) than franchise retailers (25,000 estimated as of this writing), the present invention stands to benefit many businesses across the country. Being able to offer the three primary services to an independent (financing, floor planning and technology) would be a great boon to the marketplace—one this invention seeks to bring about. Essentially then, the metamediary brings together a multiple-retailer, multiple-service provider, multiple lender marketplace for multiple consumers.

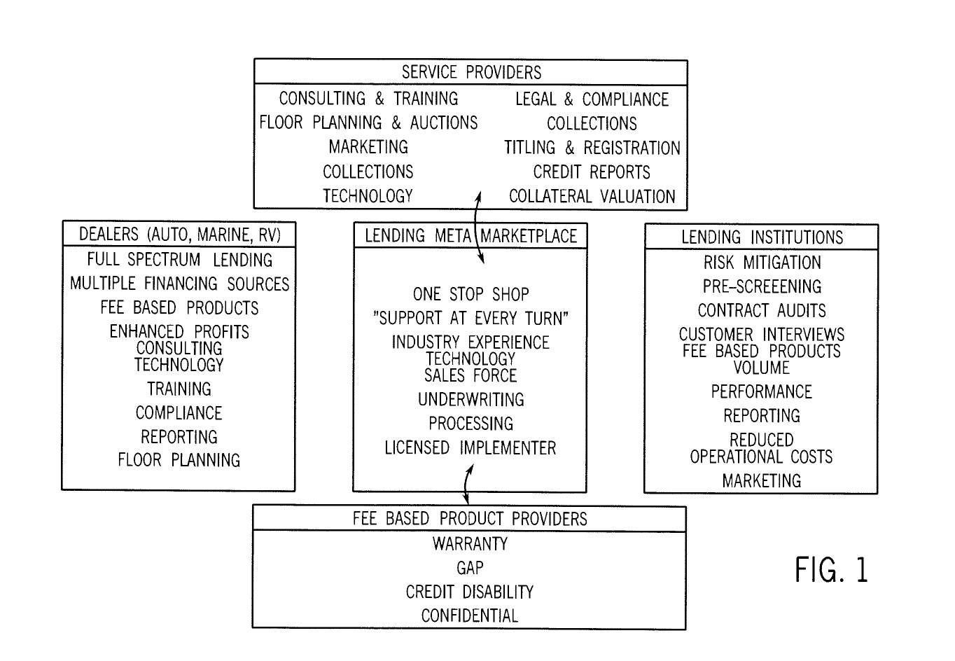

Without any intent to limit the scope of this invention, reference is made to the figures in describing the various embodiments of the invention. FIGS. 1-3 show various aspects of exemplary embodiments of the present invention.

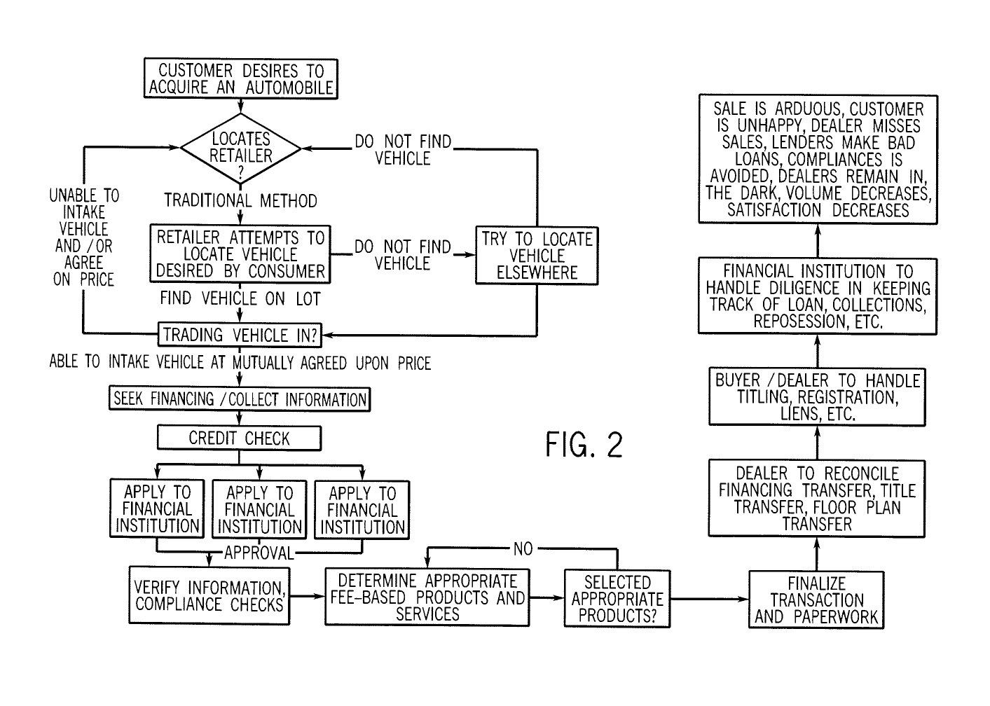

Various embodiments of the present invention relate to a “metamediary” serving a “metamarket” within the product and/or service acquisition segment. A “metamarket” is a set of related activities that accomplish a single consumer goal. In this case, the metamarket goal is that of the acquisition of, e.g., a vehicle, such as an automobile or truck. This type of transaction presently involves a multitude of individual processes, which can be time consuming and complex. In a retail setting, delays and complications are adverse to effective sales, and thus a reduction in time consumption and complexity are desired. FIG. 2 illustrates the typical fashion in which the vehicle acquisition process is accomplished, and reveals the problems and convolution therein, further demonstrating the need for a reduction in complication and time commitment.

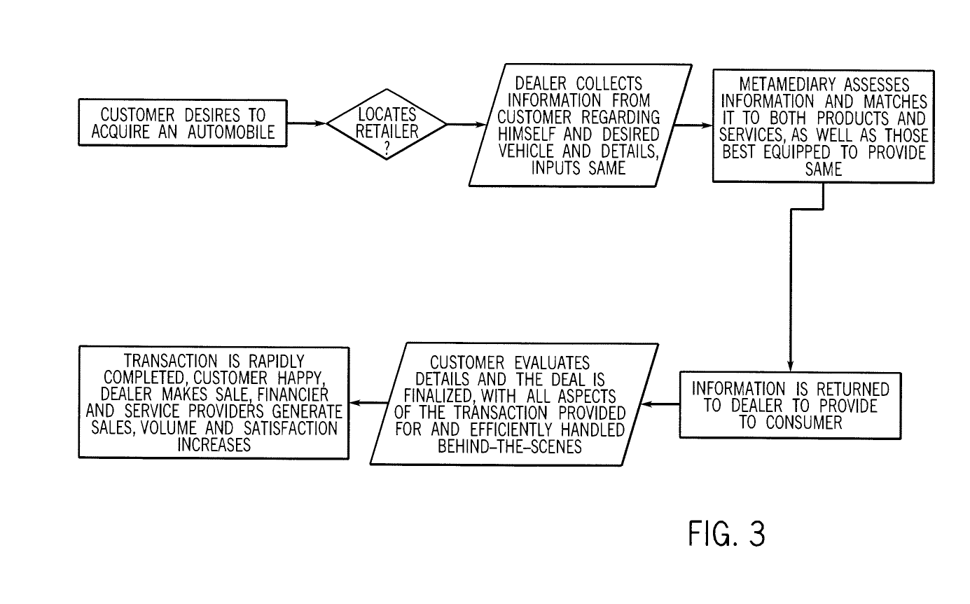

In order to achieve this designed reduction in time and complexity, a “metamediary” is proposed to be employed by the current invention. A “metamediary” can refer to a third party that routes information to appropriate destinations to present a seamless approach to the consumer. The metamediary is generally not the service or product provider, but rather serves as a “middleman”/intermediary system or router of information between the consumer and the myriad service and product providers. FIG. 1 illustrates many of the parties which can be brought together by a metamediary. The presence of this metamediary in essence is a “vendor of trust”, building a reputation for the retailer involved in the transaction. The metamediary is able to provide value and services to all entities in the transaction, but especially the retailer, financial institution and end consumer of the vehicle acquisition process. This is illustrated in FIG. 3, where a sample unified transaction is demonstrated.

In order to establish what the present invention seeks to achieve, it is beneficial to examine a typical retail transaction. Some of the players in this transaction include:
The metamediary who operates and maintains the marketplace
Lending and other financial institutions
The retailer or “dealer”
Associated retailers
Product manufacturers
Underwriting service providers
Contract processing service providers (providing loan packet audits, customer interviews, etc.)
Fee based product providers, such as warranty, GAP and credit insurance providers
Escrow providers
Consulting services providers
Sales representatives and marketing service providers
Technology providers
Legal and compliance service providers
Information service providers, such as credit agencies and product valuations
Collections service providers
Training service providers
Loan servicers
Wholesalers for dispensation of trades, etc.
Security service providers
Floor planning service providers
Auction houses/wholesalers for dealers to procure/sell inventory

As can be seen, many players exist in an acquisition transaction, and many individual considerations must be made for each element involved in such transaction. A consumer will approach a retailer, who seeks to procure, e.g., an automobile for such consumer. Such automobile many be in his inventory, or he may have to order or transfer the automobile from elsewhere. Once the automobile is located, the consumer must then decide which type of financing he will select. While some consumers will pay cash, the vast majority will finance or lease the automobile. Thus, a vendor for those services must be procured, and matched to the financial qualifications of the consumer. Once this is accomplished, value-added services, such as insurance, warranties, GAP insurance, and so forth will be offered to the consumer, depending on which financing product(s) and automotive products are being obtained, including e.g., the use of an estimated tax refund loan as a down payment. If a trade-in vehicle or vehicle is being accepted as part of the transaction, that vehicle or vehicles must be valuated, (through a service like MMR, NADA or the like) and appropriate dispensation arranged. Payoff of trade in vehicle(s) may also have to be arranged. Credit reports will need to be run, lending service providers contacted, and myriad other minutia addressed. All the while, compliance, privacy and other regulatory aspects must be maintained and laws adhered to, lest the retailers be fined due to regulatory and compliance violations. All of these aspects make the process time consuming and fraught with the possibility of error, not to mention horribly inefficient. Any such inefficiency not only costs the retailer money and time, but may result in the loss of sales due to the complications and time involved. Even should the transaction be appropriately processed, there are numerous inefficiencies that may prevent the customer from being best served, and there are numerous missed opportunities by the retailer and customer alike.

Thus, by consolidating these into the unified marketplace, several benefits may be realized by the different players in the market. Retailers, for instance, benefit by:
Offering a “One-Stop Shop” offering to end consumers
Gaining access to multiple financing sources
Being able to offer full-spectrum lending options to end consumers
The ability to offer fee-based products
Enhanced profits through rate participation and fee-based products
The use of technology solutions (DMS, F&I Software)
F&I consulting and training
Assistance in ensuring compliance
Being able to manage inventory floor planning services
Having reduced operational costs
Electronic access to wholesalers/auction houses to purchase/sell inventory
Consolidated hassle-free paperwork and loan documentation in laser/electronic format
E-contracts, or the 100% electronic transfer of contract information

Other players in the transaction also stand to gain. For instance, financial institutions are given an advantage by having:
Increased foot print, customer base and retailer base
Increased volume with minimized startup costs (legwork all done when they sign-up)
Reduced contacts points in a vehicular transaction
Expanded sales and marketing
Pre-screening performed by the metamediary or a third-party metamarketplace service provider to reduce processing time
Electronic contracting to increase productivity and reduce paperwork
Easier contract audits and review
Easier access to customer interviews
Expanded risk mitigation by virtue of a more carefully tailored end consumer and reductions in fraud, ID theft, etc., handling of repossessions and the like, also pre-screening and due diligence conducted by the metamediary or third party service provider of the retailer before signing them up
Additional fee based products revenue; increased finance amounts and commissions
Increased volume due to more compatible consumer to financier matches
Increased loan portfolio performance because consumers are better suited to the loan product(s)
Reduced operational costs as a result of fewer collections, interviews, etc., reduction in expenses associated with repossessions and across the board i.e., sales, underwriting, contracting, risk, collections and the like
Expanded access to technology solutions
Expanded consulting services

Most important to realize about the present invention is this ability to bring together players in the marketplace that might not otherwise have such an opportunity. In fact, historically, it is seen that this is the case. Retailers often have difficulty maintaining one lender, let alone multiple ones. Having each player in the market deal with so many other parties is unrealistic, if not impossible. With the present invention, however, the metamediary undertakes to make all of those connections, and they need only be made once. The metamediary can then handle all aspects of the transaction, or as many or as few as the parties to the transaction desire. The parties then all have the power to deal with these many other players, broadening their ability to negotiate, and find better-suited business transactions.

This system also gives “private label” technology to local and regional banks, providing ease of entry, customizing of information stored in the credit application, and auto-approval. This is a type of custom business logic. Further, insurance products and the like can be privately branded and resold creating additional public exposure and relationship building as a result of that publicity. Rules-based contracting is also employed, which can be setup for each lender, retailer, or other service provider. For example, some lenders may loan up to 125% of a car's loan value, but not include taxes, license fees and so on, while another lender may loan up to 100%, but include taxes and fees. There may also be a maximum debt to income ratio by some lenders, or the ratio could vary from lender to lender. By having all these factors analyzed by the metamediary, the retailer and consumer may focus on making sure the vehicle is appropriate and taking care of customer needs, rather than fighting with paperwork and product offerings.

This type of system affords the metamediary an extraordinary amount of flexibility, whereby product and service providers are contacted by the metamediary, and setup in the system. Lenders and retailers can then be assigned to the other, or the metamediary can be given the latitude to select the best-suited business partner. Similarly, some product and service providers can provide the metamediary with approval criteria, granting the metamediary the ability to approve, the product and service providers can reserve final judgment for themselves, or anywhere in between.

There can be offered a retailer management system module, which aids retailers in the intake of loan applications, the submission of same, and the general business of organizing and compiling data from consumers, service providers and the retailer.

Another module is the back-end module that would be run by the metamediary. This module is used by the metamediary to monitor retailers, maintain current data and offerings from service providers, lenders and retailers.

Lenders can also offer their dealers a loan origination system module which nearly guarantees a higher chance of being booked than a public portal or other system because the finance product is initially better suited for lenders than the “shotgun” approach by retailers now, who submit the consumer's information to several banks that the customer will not even qualify for, resulting in the banks paying an increase in application fees, and thus, lost margin. Current systems charge the lender for each application submitted, whereas the current model can be tailored to charge the lender for each application, for each qualified application or for each booked loan as the individual case may dictate. Since the number of booked loans is drastically increased because of the present invention's inherent efficiencies in this regard, processing time is reduced and thus there is no need to charge lenders, retailers or consumers for the many unapproved applications that are submitted under the current system.

Additionally, lenders can also be setup on a “back end” loan processing system, which is used to underwrite the credit applications, track contracts in transit and fund loans. This is yet another efficiency, which be tightly integrated with the loan origination system mentioned above. This is yet another way that the process can be streamlined and efficiencies realized.

Being able to incorporate products also has other advantages, particularly in the realm of floor plan financing. By utilizing the metamediary for floor planning, the retailer can avoid many problems that are typical, such as cash flow and interest. This is accomplished because the metamediary, in handling all aspects of the transaction, can immediately credit a retailer's floor plan account once a car is sold and the loan booked. Having this immediate credit of the purchase reduces the cash flow need, and also minimizes the time that a loan is moved from the floor plan to the customer, where banks are typically double-dipping on interest. This supplying of floor plan financing may be done directly by the metamediary, or, it can be tightly integrated with the metamediary's system such that a third party financier is involved, while being transparent to the retailer.

Another module that can be offered is the web/internet module which is integrated with the retailer management system and which enables a retailer to provide a private-labeled website with an application for finance online. Customers can instantly complete and transmit the application, and be notified immediately of their status for financing. This enables them to walk into the dealership knowing precisely what they are able to afford.

Other modules can be offered to retailers as well, depending on need and market. The method can be tailored to fit the retailer, lender and consumer base precisely, so that the most effective, efficient, secure and complete transactions are realized.

Also, as part of the system, the processing, assimilation of data and overall process will be distilled into a unified computer software package. The modules of the system can be represented with software modules than can be enabled or provided as part of a system. Each party will have access to the computer system based on their needs. Lenders, for example, might only have access to an application interface module, while dealers may have access to valuation, acquisition, application, location and auction modules. All modules will be tied together at the metamediary's hub, however, so that it can maintain and facilitate all the transactions and individual aspects that need to be overseen.

While much of the process may be automated, the metamediary will be constantly at work maintaining the infrastructure, adding product and service providers (e.g., tax service bureau partners), updating their information and offerings, removing outdated information and so forth, so that all the players engage in a seamless transaction, no matter which part of the transaction they participate in. New lenders can be added, and instantly appear in a retailer's offering New valuation parties can be available to financial institutions and retailers. New retailers can be made available to lenders.

With such a system, market players can then dictate how large a role in the metamarket they wish to have, or any other specifications they may wish to tailor their business to. To with, lenders could contact the metamediary to indicate they want more or less business, at which state the metamediary can work with the lender to expand the possible customer base. Similarly, a retailer can request additional consumers via an internet sales module or other avenues offered by the metamediary. Another example is that risk could be mitigated by classifying retailers on a scale (e.g., “A” “B” “C”, etc.) based on their financial background, established stability and so forth. Then, financial institutions or other product and service providers could select to deal with only certain types of retailers, or have a “lesser” party more carefully scrutinized.

Technology will be implemented to speed up the process by eliminating undesired customers or other parties from service providers who do not wish them, as well as alert parties in the transaction to any detected risks within the desired parties. This can be utilized in the reverse as well, permitting retailers to only select grade “A” lenders. This permits the market player to be able to dictate the type of establishment he or she operates. For example, a high-end luxury segment retailer may not want to attract low-income customers, and so he can maintain his “brand” or “product image” by only selecting class “A” lenders. Likewise, warranty companies may not want to deal with retailers who sell primarily cars over ten years old or lenders may not want to deal with retailers whose volume is less than 10 units per month. This system can also extend to the end customer, whereby lenders, retailers, service providers, etc., either exclude or more carefully scrutinize customers who are less than ideal for a particular transaction, e.g., if a customer has two existing car loans, they may not be as desirable as someone with no loans or could present a higher risk of a fraudulent transaction such as a straw purchase, which requires more scrutiny. The present system thus gives the power to all the players to dictate who they deal with, mitigating risk, fortifying the brand, and increasing satisfaction. In essence, all of the aspects of the transaction can be individually controlled and dispensed to the players, giving a precise product to the best-suited player in the metamarket—targeting the correct products for the correct people.

Another feature is that the metamediary, through technology and a sales force can collect statistical information on retailers to determine the scale and match promotions based on the same. For example, to move into “preferred tiers” additional information may be required of a retailer, and thus information can be aggregated for lenders.

In the same vein, service levels can be customized based on party levels and commitments. For example, if a retailer is engaged in floor planning and financing, the financed purchase can be immediately credited to the retailer, and deducted from the floor plan. In this manner, commitments can be obtained from retailers with regard to the volume of business they can commit to the metamediary, lender or other service provider (e.g., a specified percentage of business, etc.) A retailer would thus get assigned a specified level, and receive from the metamediary a commensurate service level, i.e., increased perks, preferences, or similar benefits. These retailer commitments can, in turn, be allocated to financing institutions and/or other product/service providers, which can be leveraged to obtain better finance rates, service levels and so on from those parties, which can be utilized by the metamediary and/or passed to the retailer customer. It also aids in forecasting analyses, which adds to the overall predictability of supply and demand and makes for a more consistent experience for all involved.

In this type of arrangement, the metamediary is also put in a position to be able to handle the negotiation on behalf of retailers, or on the part of itself. Rates, terms, promotions, etc. can be positioned by the metamediary to be used to its advantage. For example, if lenders are offering a special rate, the metamediary can choose to continue to sell the product to retailers at the standard rate, pass along the rate as a promotion to the retailer, use it as an incentive for particular retailers as an introductory promotion, reward high-performance retailers, or any other mode the metamediary sees fit. Also, the metamediary is in the position to negotiate on behalf of the retailer, if, for instance, the customer demands, or the transaction otherwise necessitates, compromised terms.

Another aspect of the invention is to provide a ranking or scoring system for retailers that serve and are served by the metamarket. Just as consumers are given a credit rating for their demonstrated creditworthiness, so then may these vehicle retailers be ranked and/or scored on their ability to conduct business with lenders and other service providers. Since much of what prevents lenders and service providers from dealing with independent retailers is the oftentimes high risk that comes with dealing with small to medium sized businesses that are frequently unproven in the market, a scoring system can help provide information to better informed decisions when dealing with independent retailers, and help to mitigate unwanted risk.

This is accomplished by a ranking system that takes into account several facts and characteristics of the independent retailer, or “retailer data.” By using these data as specified criteria and converting them to an objective value, a ranking can easily be made by using these criteria and data. Examples of such “retailer data” collected include, but are not limited to:
references from the retailer are collected and analyzed for negative content;
financial data for the retailer such as volume of sales, debt to income ratios, and number of deals closed in a specified period of time, current business financial statements, personal financial statements on the owner of the dealership, business federal income tax returns for past two (2) years, owner's personal federal income tax returns for past two (2) years, and business bank statements for the three (3) months prior to the independent retailer making application to metamediary;
statistical information such as the number of defaulted deals or loans to the number of successful deals or loans;
how many and the type of product sold; the type and number of customers served, such as their rating as prime or sub-prime customers;
amount of time a dealer has been operating;
any bond amount, and the company used for the bond;
state that the retailer is licensed to do business in and whether or not a finance license is required;
amount and presence of insurance (such as errors and omissions, general liability);
Floor plan or other financing history such as their current retail sources i.e., bank, credit union, finance company, in-house or broker;
Information on the principals, owners and financial officers of the retailer, such as their employment history, time in present position, criminal
Investigation into any criminal history of the owners, financial officers and management of the retailer will also be conducted;
Owner's credit score;
Verification of one (1) major auction reference;
Average number of units on lot;
Average number of units sold monthly;
Whether the owner owns the location of the dealership;
Whether the owner owns his place of residence;
Whether or not the retailer has a website;
The number of staff and whether or not the owner works at the location;
Other financial interests of the owner; and
Any other relevant data that is or may come to be known that is determined to impact the viability, creditworthiness or success of a retailer.

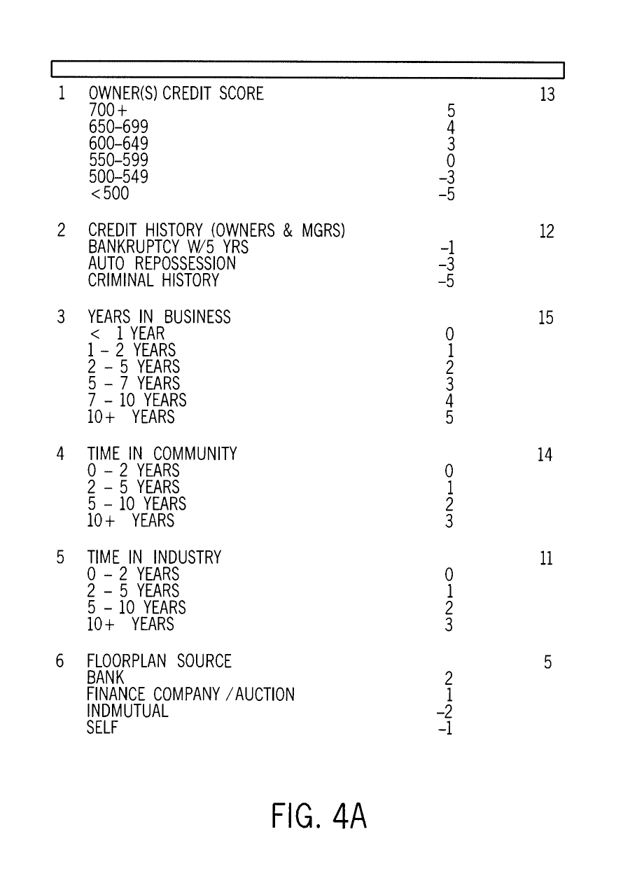

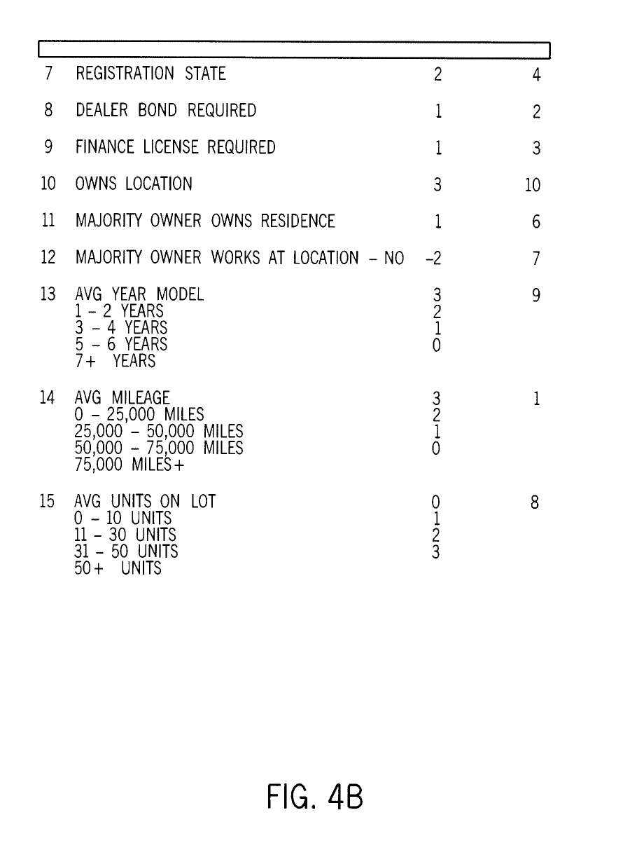

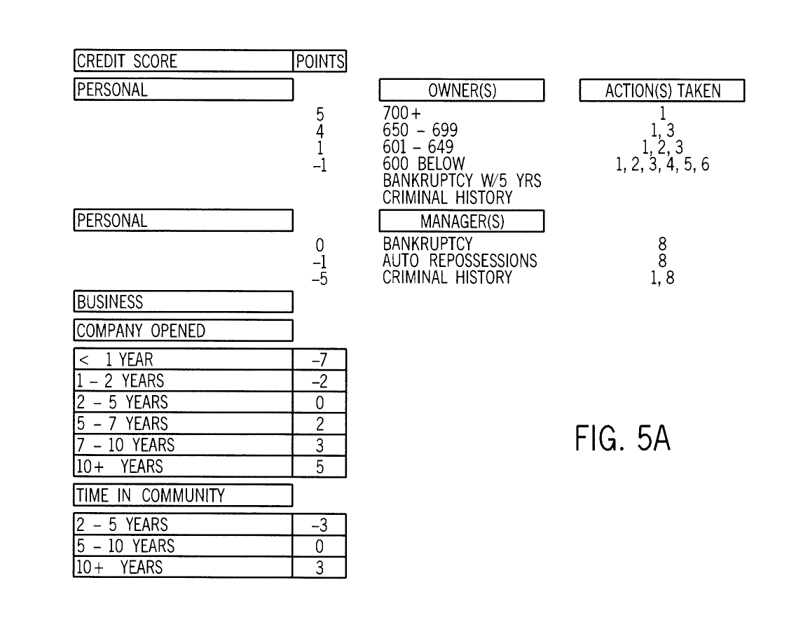

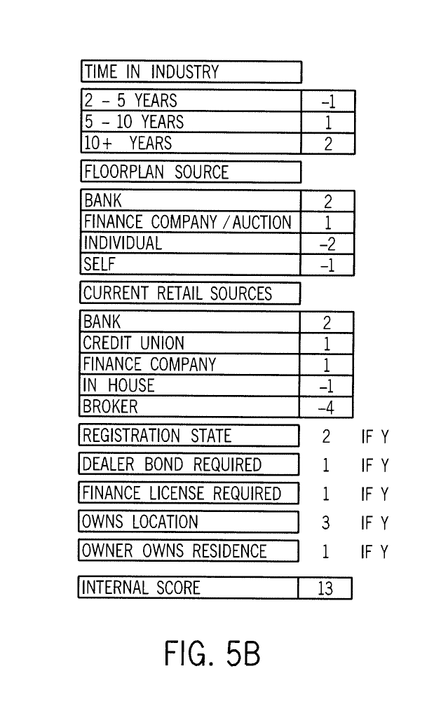

It should be noted that part of this process will nearly always include a site visit, or audit, conducted by an independent third party with whom the metamediary has contracted, to verify the information included in the scoring system as described above, as well as to determine if there are any subjective considerations that should be accounted for in the retailer's score. For example, information obtained concerning criminal history may be subjective and weighted based on the findings. Values can be determined as seen in FIGS. 4 and 5.

Once this information is factored together and weighted appropriately, it can be compared and contrasted with the historical data of the retailer itself, as well as other retailers in order to arrive at the score that will be used by lenders and other service providers in order to evaluate a particular retailer. This score may simply be the raw numerical value arrived at after the information is calculated and weighted, or it may be modified and assigned other descriptors. The range is from a minimum possible score of 0 to a maximum possible score of 300. An alphanumeric descriptor is then applied to indicate a range of numeric values as follows:

| | |
|---|---|
| 0-100 | “C” |
| 100-200 | “B” |
| 200-300 | “A” |

With a philosophy of managing risk effectively and not avoiding it, the scoring method is continually being refined as the accuracy of the information becomes clearer over time. A retailer's score is also being refined on a constant basis, not only by changing criteria, but also due to the changes that a retailer may experience over time. For example, as a dealer's experience increases, his score may go up. Conversely, a change in debt, average age of inventory or the like may cause a score to drop.

The metamediary, in order to effectively manage the risk of the marketplace and provide certain levels of efficiencies may segment the risk controls and procedures based upon the score and/or alphanumeric descriptor. For example, customer interviews are conducted for all “B” dealers, while customer interviews may be conducted every third (3^{rd}) deal for “A” dealers, etc.

It should also be noted that this information can be gathered directly by the metamediary, or the information can, in whole or part, be collected by third parties who may either already have access to such information, or who gather it themselves. In this way, this data collection can be further streamlined.

Thus, as one can clearly see, it is preferable to consolidate these and other aspects of the vehicle acquisition transaction into a metamarketplace operated by a metamediary, as provided by the current invention.

In operation, then, the metamediary positions itself by establishing connections with lenders, product and service providers and retailers, effectively assembling a set of vehicle acquisition services and products provided by service and product providers. Examples of these include lenders, warranty companies, pre-paid maintenance products, GAP Insurers, manufacturers, and the like. By establishing these connections, the metamediary then establishes links with all parties, links that would otherwise be impossible. Once these links are established, the particular information that each party requires can be recorded and made part of the metamarket infrastructure, which can then be accessed later as part of the acquisition process, establishing criteria for each of the acquisition services and products. For example, a car with more than a certain amount of mileage may not be eligible for warranty protection, or a consumer with “C” grade credit might not be eligible for borrowing from a particular lender.

The above-described ranking system may also be employed at this time by the metamediary to aid in attracting lenders and service providers to the metamarket by offering the score of the retailer, which helps to indicate the viability of the retailer, as well as helping the lender and/or service provider estimate the risk associated with dealing with a particular retailer.

Once the sufficient links are established, the system can begin to operate. Of course, additional links can be added and removed as the method is used. The metamediary is then positioned to be able to handle the transactions as received from the retailers. Once the retailer encounters an interested consumer, he can gather and input a consumer's data relevant to a vehicle acquisition, such as personal data, type of financing sought, type of vehicle, and the like into an interface, such as a computer. At that point, the metamediary, either manually, or automated through the above-mentioned interface, compares the data to the established lender or service-provider established criteria to determine a consumer's eligibility for said services and products. In relaying this information back to the retailer and then to the consumer, a retailer can determine a consumer's desired array of eligible services and products from those that he/she is eligible for. Once this is determined, the retailer can submit said consumer's data to the metamediary and in turn, to the corresponding service and product providers as defined by said desired array of services and products selected by the consumer. The corresponding service and product providers can then be contacted with the consumer's information, and in turn, transmit their approval/denial to the retailers, who receive this information from said service and product providers establishing a subset of the consumer's qualified services and products. At this point, the retailer can assess the consumer's desired services and products selected from the subset of services and products a consumer is qualified for. Finally, the acquisition process can be completed with the set of qualified services and products within said desired array and for which consumer is best qualified being finalized. This would include any necessary documentation, execution of agreements and the like, should they be necessary for the transaction.

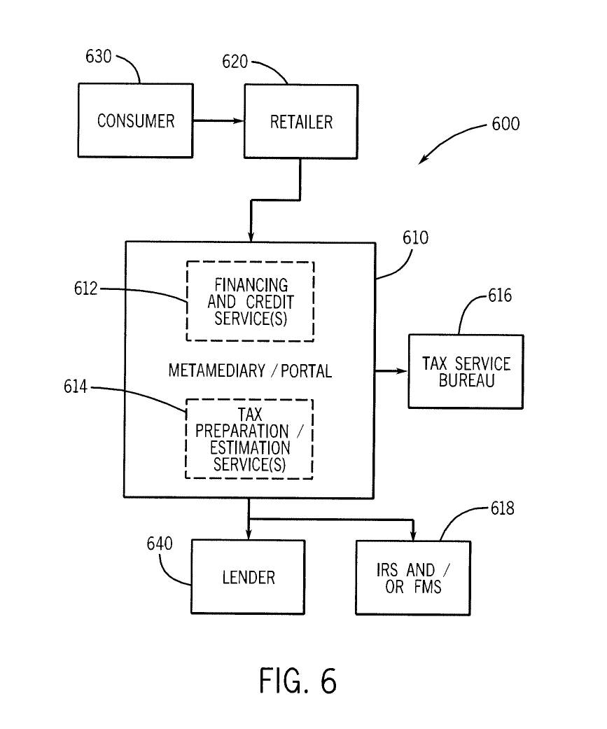

In accordance with yet another embodiment of the present invention, the metamediary enables integrated credit application and tax refund estimation services to be provided to a consumer via a “portal”, where the portal refers to, e.g., a singular access point to an integrated credit application and tax refund estimation service application/system. FIG. 6 illustrates an exemplary architecture 600 in which this embodiment of the present invention may be implemented. That is, through the metamediary/portal 610, a retailer 620 and/or a F&I manager associated with the retailer 620 is able to efficiently and non-repetitively capture tax-related data in conjunction with or in addition to completing a credit application for the consumer. It should be noted that the metamediary 610 can include various services and/or service providers, such as a financing and credit service 612, a tax preparation/estimation service 614, and a tax service bureau partner 616, as well as the Internal Revenue Service (IRS), and/or the Financial Management Service (FMS) 618. The retailer 620 may then offer to the consumer 630, an option to use some or all of the consumer's estimated tax refund as a down payment, a partial down payment, to improve a down payment on a consumer loan, payment on an existing loan, or as part of an outright purchase, e.g., supplementing a “cash” purchase. If the consumer 630 agrees to utilize at least a portion of the estimated tax refund for down payment/payment purposes, the retailer 620 incorporates the estimated tax refund into a deal structure for the consumer loan/payment. Furthermore, the retailer 120 submits the deal structure to, e.g., a lender 640, along with the credit application for a credit decision and a corresponding tax return can be e-filed with the IRS/FMS 618. Hence, the consumer may be able to purchase a product(s) or service(s) that previously would have been unattainable without the down payment/improved down payment. Alternatively, the consumer can choose not to incorporate the estimated tax refund amount into the deal structure of the consumer loan/payment and the credit application may still be submitted to the lender without the benefit of the estimated tax refund amount.

In accordance with this embodiment of the present invention, the metamediary provides access to the integrated credit application and tax refund estimation service application/system through which a retailer can obtain the integrated credit application and tax refund estimation services described above. That is, at any time before, during, or after the capturing of the credit application-related data for, e.g., a consumer loan credit application, the retailer can access the metamediary. It should be noted that accessing the integrated credit application and tax refund estimation service application/system can include but is not limited to, for example, logging into the portal and invoking a “pop-up” window that directs the retailer to an estimator interview page that guides the retailer in capturing tax-related data. Alternatively, if the retailer has already gained access to/through the portal and is in the process of, e.g., completing a credit application, the retailer can again, actuate a pop-up window that or effectuate a similar action that again will invoke the estimator interview page. Once the retailer completes an estimator interview and the relevant tax-related data is entered and/or transmitted to the metamediary, the consumer's estimated tax refund amount can be determined.

As described above, the metamediary can include various services and/or service providers. In accordance with this embodiment of the present invention, the metamediary can include at least a tax service bureau partner, a tax preparation/estimation software service, one or more partner banks/lenders, the IRS, and/or the FMS. The tax preparation/estimation software service can, as also described above, estimate a consumer's anticipated tax refund amount for a given year. Upon receipt of the consumer loan credit application (that may or may not include the deal structure incorporating the estimated tax amount), the tax service bureau partner completes a tax return on behalf of the consumer using the tax preparation/estimation software service. Additionally, the tax preparation/estimation software enables a tax return filing process, e.g., transmitting an e-file tax return to the IRS/FMS, and provides a completed tax return to the consumer. The IRS/FMS can accept the e-filed tax return and perform any necessary processes for issuing a tax refund if possible. For example, the IRS/FMS can provide debt indicators, perform audits management any delinquent debt, approve the tax return, etc. It should be noted that the tax service bureau partner and the tax preparation/estimation software service will be certified to perform these processes and additionally perform any necessary checks to ensure compliance with, e.g., federal and state tax laws for the applicable year before filing the tax return.

The lender can perform requisite operations for rendering a credit decision based upon the credit application as well as render a refund anticipation loan (RAL) decision. That is, in order for the estimated tax refund to be used as a down payment, the lender issues an RAL, which refers to a short-term loan secured by and repaid directly from the proceeds of a consumer's tax refund from the IRS. An RAL is generally granted within one to three days and settled within seven to fourteen days. Although any type of customer may utilize an RAL, RALs are generally useful for consumers that are considered to be “un-banked” or “under-banked.” Un-banked and/or under-banked consumers are those consumers that have limited or an entirely nonexistent relationship with any type of depository institution for financial transactions, e.g., consumers with poor credit history, lack credit history, immigrants, etc.

Different types of RALs may be issued in addition to that described above. For example, a lender may issue an instant RAL (IRAL), which is similar to a standard RAL with the exception that an application decision made with respect to an IRAL is available within minutes, for example, of submitting a consumer loan credit application. Additionally, the application decision is made prior to any acknowledgement from the IRS, and a partial loan based on the IRAL is granted in a substantially immediate manner. Once the lender approves the remainder of the IRAL, a second disbursement can be made. IRALs can generally be settled within seven to fourteen days. Alternatively still, a direct deposit RAL (DDRAL) may be issued by the lender. Like an RAL, a DDRAL refers to a short-term loan secured by an repaid directly from the proceeds of a consumer's tax refund from the IRS that can be granted within one to three days and settled within seven to fourteen days. However, in contrast to the standard RAL, a DDRAL can be used for those consumers that have a bank account within which the DDRAL can be directly deposited.

Electronic refund checks (ERCs), although not a loan, may also be utilized by consumers to receive their tax refund, where the tax refund is received in the form of a printed check. ERCs can be utilized by un-banked or under-banked consumers that require completion of their tax returns as well as access to their tax returns without any cash/out-of-pocket expenses. Funds from a consumer's tax return are made available once the IRS deposits the tax refund into a temporary bank account that has been set up on behalf of the consumer, where the funds can be typically deposited within ten to fourteen days. It should be noted that if a consumer cannot receive an RAL, the ERC can be used to disburse the consumer's tax refund. In the case of the ERC, the ERC can be automatically printed at an origination location (e.g., location of the loan/payment origination). Direct deposit refunds (DDRs) are similar to ERCs with the exception that the consumer can receive their tax refund via direct deposit to their own bank account.

Upon approval of the consumer's tax return, the lender issues one of a RAL, IRAL, DDRAL, ERC, or DDR to the consumer via the metamediary. Additionally, the lender can administrate the creation and maintenance of any temporary bank accounts needed for the receipt of the consumer's approved tax refund from the IRS/FMS. The metamediary in turn, provides any compliance documentation required to close and/or fund the consumer loan, deliver a “clean deal jacket,” and guarantee lien perfection. The retailer then provides the funds from the RAL, IRAL, DDRAL, ERC, or DDR to the consumer and closes the loan and finance transaction. Additionally, the retailer, through the metamediary, can monitor and research the status and any relevant acknowledgements related to credit application, tax return, and/or refund anticipation loan transactions, as well as any checks or transferred funds. Once the RAL, IRAL, DDRAL, ERC, or DDR is received by the consumer, the consumer then may purchase the desired product(s) or service(s) using the received funds for a partial or full down payment as described above.

In accordance with various embodiments of the present invention, fees incurred by the consumer and/or retailers for utilizing the integrated credit application and tax estimation service of the metamediary can be structured in various ways. For example, with respect to an RAL, the following fees may be charged: an RAL lender fee; a refund origination fee; a fee for utilizing the metamediary's services; a tax service fee; and a tax preparation/estimation software service fee. The RAL lender fee can be paid to the partner bank/lender, the refund origination fee can be paid to the retailer, and the remaining fees can be paid to the various service providers included in the metamediary as deemed appropriate. Additionally, the partner bank/lender can provide additional incentive payments to the metamediary for each RAL, IRAL, DDRAL, ERC, or DDR processed.

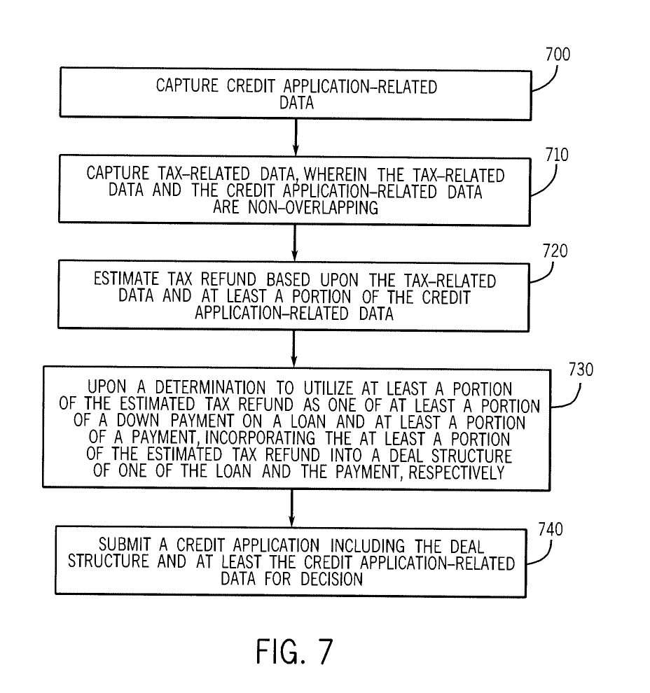

FIG. 7 is a flow chart illustrating various operations performed in accordance with this embodiment of the present invention. At 700, credit application-related data is captured. At 710, tax-related data is captured, wherein the tax-related data and the credit application-related data are non-overlapping. As described above, the integrated credit application and tax refund estimation service application/system can guide and/or capture the tax-related data and the credit application-related data without necessitating the re-entry or duplication of a consumer's relevant information. At 720, a tax refund is estimated based upon the tax-related data and at least a portion of the credit application-related data. At 730, upon a determination to utilize at least a portion of the estimated tax refund as one of at least a portion of a down payment on a loan and at least a portion of a payment, incorporating the at least a portion of the estimated tax refund into a deal structure of one of the loan and the payment, respectively. Additionally, at 740, a credit application including the deal structure and at least the credit application-related data is submitted by the metamediary to, e.g., a partner bank/lender for a decision.

The integrated credit application and tax refund estimation service application/system described herein can be leveraged for use in a variety of industries, where retailers can be matched with banks/lenders in a network for underwriting prime, sub-prime, and un-banked/under-banked loans. Increased revenue for one or more of the service providers included in the metamediary is achieved by gaining, e.g., fee-based revenues as described above, as well as the opportunity to network with a plurality of related service providers, such as “independent,” “buy-here-pay-here,” and franchise retailers/dealers. Financing can be achieved for a greater number of purchases than conventionally possible, and delinquent receivables can be reduced. Additionally, consumers and retailers are provided with efficient processes for obtaining alternative financing, as well as providing consumers the ability to make fast, well-informed, and compliant financing decisions.

It is important to know that though “services and products” is used in the plural throughout this application, this can refer to a single service and/or product, or no services and/or products should that be the transaction ultimately available or desired to or by a consumer. Additionally, it should be noted that although exemplary embodiments and aspects of the present invention are described in the context of vehicle acquisition and/or financing, various embodiments and/or aspects of the present invention are applicable to the acquisition and/or financing of other products and/or services.

It is also a component of this application to claim a software interface method for employing this technique. Clearly, with the assistance of computers and networking components, this process may be streamlined. Data entry, storage and remission can be utilized to reduce processing time and to retain often used data. Data relating to service and product providers may only have to be entered once, and consumer data can be updated rather than re-entered or transcribed for each application for a service or product.

Various embodiments described herein may utilize existing computer capabilities, both hardware and software, and electronic communication links, for example, to receive and process (e.g., in real time) financial and/or tax-related data provided by a retailer, a lender, a tax preparation service, etc. An exemplary computer system or device may include a general purpose computing device including a processing unit, a system memory, and a system bus that couples various system components including the system memory to the processing unit. The system memory may include read only memory (ROM) and random access memory (RAM). The computer may also include a magnetic hard disk drive for reading from and writing to a removable magnetic disk, and an optical disk drive for reading from or writing to a removable optical disk such as a CD-ROM or other optical media. The drives and their associated computer-readable media provide nonvolatile storage of computer-executable instructions, data structures, program modules, and other data for the computer. The various logic elements may be implemented on a separate logical server or using separate physical devices.

Exemplary computer systems or servers may operate under the control of computer software to carry out the process steps described herein. Computer software for each system or engine may include a set of software objects and/or program elements including computer-executable instructions collectively having the ability to execute independently in a separate thread or logical chain of process evaluation, while permitting the flow of data inputs therebetween. Computer-executable instructions comprise, for example, instructions and data which cause a general or special purpose computer system or processing device to perform a certain function or group of functions.

Data may be communicated between the various systems and engines of system 200 in real time over the Internet or other computer network environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. It will be appreciated that such network computing environments will typically encompass many types of computer system configurations, including personal computers, hand-held devices, multi-processor systems, microprocessor-based or programmable consumer electronics, network PCs, minicomputers, mainframe computers, and the like.

It will be further be appreciated that system and method described herein may perform fewer or additional functions as compared to those described herein. For example, an entity (e.g., a retailer or metamediary) that performs and/or utilizes only some of the above-mentioned processes may use a computer system that contains only a subset of the functions described herein. Additionally, one or more of the systems or functions described above may be variously combined in alternative configurations.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A method, comprising:
capturing credit application-related data;
capturing tax-related data, wherein the tax-related data and the credit application-related data are non-overlapping;
estimating a tax refund based upon the tax-related data and at least a portion of the credit application-related data;
upon a determination to utilize at least a portion of the estimated tax refund as one of at least a portion of a down payment on a loan and at least a portion of a payment, incorporating the at least a portion of the estimated tax refund into a deal structure of one of the loan and the payment, respectively; and
submitting a credit application including the deal structure and at least the credit application-related data for decision.

2. The method of claim 1, wherein the capturing of the credit application-related data and the tax-related data, the estimating of the tax refund, the incorporating of the at least a portion of the estimated tax refund, and the submitting of the credit application is performed by a single integrated credit application and tax refund estimation service system.

3. The method of claim 2, wherein the integrated credit application and tax refund estimation service system comprises at least one of a financing and credit service, and a tax preparation and estimation service.

4. The method of claim 1, further comprising e-filing a corresponding tax return to the Internal Revenue Service.

5. The method of claim 1, further comprising, upon a determination not to utilize at least a portion of the estimated tax refund as one of the at least a portion of the down payment on the loan and the at least a portion of the payment, submitting a credit application without including the deal structure.

6. The method of claim 1, wherein the loan comprises one of a consumer loan to be used by a consumer to purchase at least one of a product and a service and an existing loan.

7. The method of claim 1, wherein the estimating of the tax refund occurs at least one of before, during, and after completion of the credit application.

8. The method of claim 1, wherein distribution of the estimated tax refund to a consumer for which the credit application is submitted is performed via one of a refund anticipation loan, an instant refund anticipation loan, a direct deposit refund anticipation loan, an electronic refund check, and a direct deposit refund.

9. The method of claim 8, wherein the distribution of the estimated tax refund to the consumer is performed via one of the electronic refund check and the direct deposit refund upon a determination that the consumer does not qualify for one of the refund anticipation loan, the instant refund anticipation loan, and the direct deposit refund anticipation loan.

10. The method of claim 8, further comprising at least one of administrating and maintaining a temporary bank account on behalf of the consumer to receive the distribution of the estimated tax refund.

11. The method of claim 8, further comprising automatically printing the electronic refund check at an originating location.

12. An apparatus, comprising:
a processor; and
a memory unit operatively connected to the processor and including:
computer code configured to capture credit application-related data;
computer code configured to capture tax-related data, wherein the tax-related data and the credit application-related data are non-overlapping;
computer code configured to estimate a tax refund based upon the tax-related data and at least a portion of the credit application-related data;
computer code configured to, upon a determination to utilize at least a portion of the estimated tax refund as one of at least a portion of a down payment on a loan and at least a portion of a payment, incorporating the at least a portion of the estimated tax refund into a deal structure of one of the loan and the payment, respectively; and
computer code configured to submit a credit application including the deal structure and at least the credit application-related data for decision.

13. The apparatus of claim 12, wherein the memory unit further comprises computer code configured to perform processes associated with at least one of a financing and credit service, and a tax preparation and estimation service.

14. The apparatus of claim 12, wherein the memory unit further comprises computer code configured to e-file a corresponding tax return to the Internal Revenue Service.

15. The apparatus of claim 12, wherein the memory unit further comprises computer code configured to, upon a determination not to utilize at least a portion of the estimated tax refund as one of the at least a portion of the down payment on the loan and the at least a portion of the payment, submitting a credit application without including the deal structure.

16. The apparatus of claim 12, wherein the loan comprises one of a consumer loan to be used by a consumer to purchase at least one of a product and a service and an existing loan.

17. The apparatus of claim 12, wherein the estimating of the tax refund occurs at least one of before, during, and after completion of the credit application.

18. The apparatus of claim 12, wherein distribution of the estimated tax refund to a consumer for which the credit application is submitted is performed via one of a refund anticipation loan, an instant refund anticipation loan, a direct deposit refund anticipation loan, an electronic refund check, and a direct deposit refund.

19. The apparatus of claim 18, wherein the distribution of the estimated tax refund to the consumer is performed via one of the electronic refund check and the direct deposit refund upon a determination that the consumer does not qualify for one of the refund anticipation loan, the instant refund anticipation loan, and the direct deposit refund anticipation loan.

20. The apparatus of claim 18, wherein the memory unit further comprises computer code configured to at least one of administrate and maintain a temporary bank account on behalf of the consumer to receive the distribution of the estimated tax refund.

21. The apparatus of claim 18, wherein the memory unit further comprises computer code configured to automatically print the electronic refund check at an originating location.

22. A system, comprising:
a first application configured to capture credit application-related data; and
a second application configured to:
capture tax-related data, wherein the tax-related data and the credit application-related data are non-overlapping;
estimate a tax refund based upon the tax-related data and at least a portion of the credit application-related data;
upon a determination to utilize at least a portion of the estimated tax refund as one of at least a portion of a down payment on a loan and at least a portion of a payment, incorporating the at least a portion of the estimated tax refund into a deal structure of one of the loan and the payment, respectively; and
submit a credit application including the deal structure and at least the credit application-related data for decision;
wherein the first application and the second application are accessible via a single portal.
